(19) United States
(12) Patent Application Publication
(10) Pub. No.: US 2022/0220020 A1
(43) Pub. Date: Jul. 14, 2022

(54) METHOD FOR FLOCCULATING SOLID PARTICLES CONTAINED IN A SUSPENSION, AND SYSTEM FOR CARRYING OUT THE METHOD

(71) Applicant: KAM Analysen- und Messtechnik GmbH, Egloffstein (DE)

(72) Inventors: Michael Kocher, Egloffstein (DE); Mohammad Reza Vali, Hürth (DE); Werner Krüger, Kerpen (DE); Matthias Albers, Hilden (DE)

(21) Appl. No.: 17/606,565

(22) PCT Filed: Apr. 16, 2020
(86) PCT No.: PCT/EP2020/060713

§ 371 Date: Oct. 26, 2021

(30) Foreign Application Priority Data
Apr. 26, 2019 (DE) 10 2019 110 830.6

(51) Int. Cl. C02F 11/147; C02F 11/127; C02F 1/00

(52) U.S. Cl. CPC C02F 11/147; C02F 11/127; C02F 2209/05; C02F 2209/006; C02F 1/008

(57) ABSTRACT

Methods for flocculating solid particles in a provided suspension including specifying a target charge density of the suspension at which the solid particles flocculate; providing a flocculant having a charge density; determining, at a plurality of measuring times, the suspension charge density present in the suspension in the course of a titrimetric analysis, measuring the flow potential; determining, at respective of the measuring times, a quantity of the flocculant needing to be added to ensure optimal flocculation based on the target charge density, the flocculant charge density, and the suspension charge density present at the respective measuring time; and subsequently adding the determined quantity of flocculant into the suspension; and systems therefor. The methods and systems can provide the actual demand of flocculant needed for efficient flocculation in a continuous flocculation method of a suspension.

### CROSS-REFERENCE TO RELATED APPLICATIONS

This application is a national stage application of international application no. PCT/EP2020/060713 filed Apr. 16, 2020, claiming priority under 35 U.S.C. § 119(a)-(d) to German application no. DE 10 2019 110 830.6 filed Apr. 26, 2019, which are hereby expressly incorporated by reference as part of the present disclosure.

### FIELD OF THE INVENTION

### The Present Disclosure Relates to Methods and Systems for Flocculating Solid Particles Contained in a Suspension Backgound

In order to carry out the separation of solid-liquid mixtures of substances in said fields, a primary requirement is the formation of flocculates or the aggregation or coagulation of solid particles. Particularly in the case of sludge dewatering, the formation of a sludge floc which is easy to dewater is of paramount importance. Thus, waste water sludges in waste water treatment plants, for example, initially have to be flocculated before they can be dewatered. Sludge dewatering in this regard is downstream of the treatment process per se. The waste water sludge is the “waste product” of the treatment process. Depending on the design of the treatment process or of the waste water treatment plant, however, flocculation may be carried out even before the dewatering, for example upstream of the sludge digestion.

Flocculation processes can be initiated and/or accelerated by adding suitable flocculating agents. This can improve coagulation and/or flocculation of the solid particles contained in a suspension. Similarly, by this means, the procedural steps of sedimentation, flotation or filtration in a solid-liquid separation process can be improved. From a procedural viewpoint, the flocculation can be carried out both continuously and discontinuously. In a continuous procedure, flocculation occurs at a continuous volumetric flow.

As already indicated, flocculation processes play a significant role in the separation of solid-liquid systems such as suspensions. A “suspension” should be understood to mean a heterogeneous mixture of substances formed by a liquid and solid particles distributed in the liquid. A suspension may also be described as a disperse solid phase in a continuous liquid phase. The characteristic feature of a suspension is that when the system is allowed to stand, after a certain period of time (in contrast to a “true” chemical solution), the solid particles settle onto the bottom in the form of a sediment. The liquid above the deposit on the bottom can be separated from the solid by simple means, for example by decanting.

It should be expressly emphasized at this juncture that the invention is absolutely not limited to a specific order of magnitude of solid particles distributed in a liquid. Thus, the invention can also be employed in principle with colloidal solutions by coagulating the colloidal particles contained therein. Equally, the invention may also be implemented in the context of precipitation processes, in which particles dissolved in a liquid are precipitated by the addition of a precipitating agent and transformed into a solid phase. In the context herein, when the terms “coagulation”, “flocculation” or a “flocculating agent” are used, this should be understood to also include precipitation with a precipitating agent. Furthermore, it should be emphasized that the term “flocculating” or “flocculation” should be understood to be synonymous with the term “aggregation” or “coagulation”. All of these processes are encompassed by the invention. It should also be mentioned that the term “flocculating agent” used herein in the context of the description can encompass any type of flocculating agent, whether it is a flocculating agent of an inorganic, organic or polymeric nature. The term “flocculating agent” also encompasses, inter alia, what are known as polymeric flocculating agents (abbreviated to pFA).

The solid particles contained in an (aqueous) suspension usually have a specific surface charge which prevents flocculation by electrostatic repulsion by forming what is known as a Helmholtz double layer. Suspensions of this type are also termed “stable” suspensions. Adding auxiliary substances (hereinafter termed flocculating agents, which encompasses both coagulants as well as flocculants) equalises the charges on the surface of the solid, whereupon the suspension is destabilized and flocculation is made possible. The added flocculating agents in this regard usually have a specific charge. At what is known as the isoelectric point (complete equilibration of the charges), anionic and cationic charges cancel each other out and the solids can coagulate or flocculate. Separation of the solid from the liquid phase can then occur.

In the field of sewage sludge dewatering, solid-liquid separation is often carried out during a continuous dewatering process, for example with the use of decanter centrifuges or screw presses. However, in this regard, no processes are known which can determine an appropriate addition of a flocculating agent until the isoelectric point is reached in a continuous dewatering process. Without such an appropriate adjustment of the flocculating agent, in the event of fluctuating infeed qualities of the suspensions to be dewatered (i.e., for example, differing proportions of solid or different solid compositions), the flocculating agent might be dosed incorrectly. This is accompanied by a reduced efficiency for solid-liquid separation. In addition, an unwarranted overdosing of flocculating agent is accompanied by an unnecessary material consumption and increased costs.

The dosing of flocculating agents is known to be carried out in proportion with the calculated solid load of the suspension, but also by monitoring the eliminated liquid phase by means of a streaming potential measurement or by monitoring the eliminated liquid phase using an optical method.

In addition to said calculation and instrumentational techniques, however, methods are also known which are based on the experience of the operating personnel in a dewatering plant, for example by way of visual inspection (visual examination, feeling textures, etc.).

The problem that arises with the known method is that a quantitative assessment of the excess/deficit of added flocculating agent is not possible. The use of a streaming potential measurement could not in the past provide any usable results because the streaming potential is also additionally dependent on the conductivity, viscosity and proportion of solid in the suspension in addition to the charge of the suspension. As an example, when the concentration of salt varies, until now, no relationship between the proportion of solid and an excess/surplus of flocculating agent could be produced.

In the case of load-proportional dosing of flocculating agents, which is also known, the possibly variable composition of the suspension may be problematic because the solid particle content does not allow any predictions to be made regarding its surface charge and other interactions with the suspension.

Furthermore, the use of colour-coded flocculating agents is known, which can indicate an excess of flocculating agent by means of a coloration. A method using an indirect back-titration with a colour change as the indication of the end point is also known. The problem with the treatment of suspensions with flocculating agents, however, is that the determination of charge equilibration is influenced by mechanical stress (for example centrifugation, pressing), which in practice often leads to unnecessary overdosing of the auxiliary substances.

### SUMMARY

Correspondingly, one objective is to provide herein methods for the flocculation of solid particles contained in a suspension, as well as systems therefor, by means of which the actual requirement for flocculating agent required for efficient flocculation can be provided in a continuous method for the flocculation of a suspension. In this regard, methods or systems described herein concern suspensions occurring in waste water treatment, chemical production and drinking water treatment, and can be implemented in the field of sewage sludge dewatering and thickening of the suspensions occurring therein, i.e. in aqueous systems.

As already mentioned, this disclosure concerns a method for flocculating solid particles contained in a suspension. An exemplary method comprises at least the steps of the method detailed below.

Thus, a first step a. of the method concerns the provision of a suspension and specification of a target charge density for the suspension, with the proviso that the target charge density is that charge density of the suspension at which the solid particles flocculate. The term “provision of a suspension” in this context should be understood to mean establishing a specific suspension which is to undergo flocculation (for example as a sub-step in a dewatering process), i.e. ultimately the selection of a specific investigation system. This is principally a suspension which is introduced continuously or in batches into a dewatering assembly, and which undergoes single-step or multi-step dewatering in the dewatering assembly. The method concerns that step of the method in the dewatering process in which flocculation of the solid particles contained in the suspension occurs.

Said target charge density concerns a target value for the charge density to be obtained in the suspension. It pertains to that charge density of the suspension at which flocculation of the solid particles in the suspension which is as complete and efficient as possible can be guaranteed. The target charge density is dependent on the type and composition of the suspension which is actually present. It therefore reflects the ideal charge density for flocculation of a specific suspension. In principle, the target charge density has an idealized value of 0 μeq/L. In the event of deviations, the target charge density has to be determined empirically in large-scale tests on the appropriate dewatering assembly. A determination in a separate laboratory test may also be considered. During the laboratory test, the quantity of flocculating agent which is required for optimal flocculation is determined, for example by means of a titration. The optimal quantity of the flocculating agent may also be given in the form of a target concentration or target quantity of substance. The target charge density of the suspension may therefore be that charge density which is present when the isoelectric point is reached or neared. Thus, clearly, the target charge density may also differ from the charge density present at the isoelectric point. The target charge density may be determined by means of laboratory tests, however the target charge density may also be freely determined.

In a further step b. of the method, a flocculating agent is provided wherein the flocculating agent has a flocculating agent charge density. The term “provision of a flocculating agent” should be understood to include the synthesis, ordering, supply, i.e. basically the use of a specific flocculating agent. The type of flocculating agent is selected as a function of the suspension which is provided; however, e.g., charged polymers may be considered as flocculating agents (for example charged pFAs). The flocculating agent charge density may be given by the manufacturer of the flocculating agent, or be determined separately. In this regard, the flocculating agent charge density may be determined by way of a separate laboratory test. This means the determination of the flocculating agent charge density in the context of a colloidal titration based on the streaming potential. In this regard, an anionic or cationic titrant with a known molarity is employed.

In a further step c. of the method, the prevailing suspension charge density in the suspension is determined for a plurality of measurement time points, namely by way of a titrimetric analysis with measurement of the streaming potential. In this regard, both cationic and anionic titrants may be considered. Examples of possible cationic titrants which may be cited are polyamines or polyamine salts and poly-DADMAC (polydiallyldimethylammonium chloride). Examples of possible anionic titrants which may be cited are PEs-Na (sodium polyethylene sulphonate) and KPVS (potassium polyvinyl sulphate). In this regard, the measurement is carried out in a measuring cell which may be a component of a measuring device which is specifically provided for this purpose. The measuring device may be disposed in the immediate vicinity of a dewatering assembly containing the suspension, or it may be stationary and integrated into the dewatering assembly. The measuring device may also be configured as a mobile measuring device. In all cases, however, it must be ensured that the measuring device or the measuring cell can be supplied with samples of suspension via a suitable feed line. Supply may, for example, be ensured by means of a pump or an appropriate suction device. As already mentioned, the titrimetric analysis may be carried out at a plurality of measurement time points. Continuous monitoring of the suspension charge density over a specific period of time for the dewatering process enables an appropriate addition or adjustment of the flocculating agent to be carried out. The period of time may also extend over the entire time period of the dewatering process. In continuous dewatering processes, i.e. in processes in which a suspension to be dewatered is continuously fed to a dewatering assembly, the plurality of measurement time points does not have to be limited to a specific time period, but rather the measurements may also be carried out continuously (at specific time intervals). The time interval for the measurement time points is limited by the time taken for the individual measurements. The maximum achievable time resolution is thus orientated towards the duration of step c. of the method with respect to an individual measurement time point.

The analysis or measurement carried out in the context of step c. of the method is based on a charge titration with measurement of the streaming potential using a streaming current detector. In this regard, excess flocculating agent (for example a charged polymer), for example, is deposited on a wall of the measuring cell. The surface charge of the flocculating agent is compensated for by counterions from the surrounding solution. The counterions are initially deposited in a stable inner layer (what is known as the star layer) and in a displaceable outer layer. The transition between the layers is termed the slipping plane. In order to measure the streaming potential, a Teflon plunger is displaced along its longitudinal axis in a rapid, reversible movement. Because of the small distance from the walls of the measuring cell, the resulting flow leads to shearing of the displaceable ion layer, whereupon a measurable electrical potential is set up along the wall of the measuring cell. In order to set up the electrical potential, particles with a surface charge have to be deposited on the wall of the measuring cell. Assuming that only the (polymeric) flocculating agent used in the context of flocculation process is capable of being deposited on the wall, then the measured electrical potential is directly related to an excess of free flocculating agent (for example polymer). In this regard, the term “free flocculating agent” means those flocculating agent molecules or flocculating agent particles with surface charges which are not compensated for by appropriate counterions (for example surface charges of the solid particles in the suspension). In the event that no excess flocculating agent is present, the walls of the measuring cell are coated with other polyelectrolytes or similarly-reacting substances (for example charged particles from the suspension). The measurement is then carried out in a manner which is analogous to the aforementioned procedure, but with a different sign for the charge density. The measurement device is thus capable of detecting both an excess and a deficit of flocculating agent and to adjust the dose appropriately.

With suitable titrants (these may also be charged polymers), the excess of flocculating agent can be titrated by forming stable ion pairs. Flocculating agent bound into ion pairs is no longer deposited on the wall and can therefore also not be deposited as an ion layer which can shear. Thus, the measurable electrical potential falls during the titration until the flocculating agent no longer contributes to it. The charge on the flocculating agent is completely compensated for at this point by the titrant. Upon titration beyond this point, the measurable potential is determined by the titrant itself. The point of electrical neutralisation of the flocculating agent (isoelectric point) can therefore be determined exactly. In principle, a determination of the free surface charge of the solid particles of the suspension is also possible in this manner. This case occurs, for example, if too little flocculating agent is added to the suspension to compensate for the charge. The measurement device or measuring cell detects the situation which is in fact present with the aid of the sign of the charge density and can automatically select a suitable titrant. The titration carried out at the respective points in time can be carried out in an automated manner.

In a further step d., a quantity of the flocculating agent to be added at the respective measurement time points in order to guarantee an optimal flocculation is determined based on the target charge density of the suspension, the flocculating agent charge density and the suspension charge density at the respective measurement time point. In order to determine the necessary quantity to be added, firstly, the difference between the target charge density for the suspension and the measured suspension charge density is calculated. The quotient of the difference determined in this manner and the flocculating agent charge density enables the quantity to be added to be calculated. In this regard, the required quantity to be added may, for example, be given in the form of the volume of flocculating agent required per unit volume of suspension. When the supply data for the suspension into the measurement assembly is known, the quantity to be added can also be transformed into other reference values, for example into the volume of flocculating agent required per unit mass of the suspension or the volume of flocculating agent required per unit time.

Because the required quantity of the flocculating agent to be added is determined at a plurality of measurement time points, it may be provided that when calculating the quantity to be added at a specific measurement time point, the quantity to be added at a measurement time point which precedes the actual measurement time point is taken into account, for example by way of adding a value. Depending on the control algorithm (specific examples are described later), it may also be envisaged that the quantity to be added is taken into account by way of a load-proportional dosing onto a specific solid content of the suspension. Multiplying the determined quantity to be added by a specific multiplication factor may also be envisaged. The multiplication factor in this regard may, for example, be determined empirically or by calculation.

In a further step e. of the method, following the respective measurement time points, the determined quantity of flocculating agent to be added may be added. If the determined quantity to be added is zero, then no more flocculating agent is added to the suspension for at least a specific time period (for example until the next measurement time point). By means of the appropriate addition of the flocculating agent, variations in the process conditions or in the composition of the suspension (in a continuous process, for example because of a variable infeed) during the flocculation process or the dewatering process can be taken into consideration. As a consequence, at the respective addition time points following the measurement time points, only the quantity of flocculating agent which is actually required for optimal flocculation is added. On the one hand, this means that the efficiency of the flocculation procedure is optimised, and on the other hand, an unnecessary consumption of chemicals is avoided.

The features disclosed herein may be used in any combinations in order to further develop the method as well as the system, as long as this is technically feasible. This is also the case if combinations of this type are not expressly illustrated.

In accordance with an embodiment of the method, the target charge density may be determined by way of a separate laboratory test, for example by way of a titration. In this regard, a sample may be removed manually or in an automated manner from the suspension for the flocculation process or the dewatering procedure and the target charge density may be determined by titration. As already described above, the target charge density provides the ideal charge density for flocculation of a specific suspension (or the suspension to undergo the flocculation procedure). In the context of the laboratory test—for example by way of a titration—the quantity of flocculating agent required for an optimized flocculation process is determined. The target charge density of the suspension may therefore be that charge density when the isoelectric point is reached. With respect to a possible application of the method to sludge dewatering, the target charge density is determined with the aid of the specific conditions of the sludge to be dewatered. In this regard, the optimal quantity of flocculating agent (such as charged polymer) required for flocculation is determined. The measured (and required) excess of flocculating agent is set as the target charge density. If no excess is necessary, then the value for the target charge density is set at zero in the ideal case. It should be noted that the target charge density can in principle be set, as a function of the conditions in the flocculation process, at any value with a positive or negative sign, including zero. The determination of the target charge density in specific (specifiable) intervals of time may be repeated, which may be of advantage e.g., in a continuous dewatering process. However, at the same time, the target charge density may be determined for a specific suspension only once or regularly, such as prior to the start of the dewatering process or prior to adding the flocculating agent. A single determination of the target charge density of the suspension prior to the start of the flocculation process is suitablein the context of a discontinuous dewatering process, i.e. a predetermined quantity or a predetermined volume (i.e. a batch) of a suspension to be dewatered is gradually dewatered (for example with the continuous addition of flocculating agent). In this case, then, a specific quantity of a suspension to be dewatered or to be subjected to the flocculation process is fed into a dewatering assembly only once. There is no continuous feed.

As already mentioned above, it may be advantageous for the flocculating agent charge density to be established, derived from empirical data or be determined by way of a separate test, for example by way of a titration which is carried out automatically in the measurement device or in the laboratory. In this regard, either the flocculating agent charge density may be provided by a flocculating agent manufacturer who carries out a laboratory test, or this can clearly also be carried out by the user. In addition, the charge density of the flocculating agent may be established by way of a titration based on the streaming potential. In the case of the use of a charged polymer as the flocculating agent, the titration which is undergone is usually known in the art as a colloidal titration using the streaming potential.

As a rule, the flocculating agent (for example a charged polymer or pFA) is prepared in an aqueous batch solution. The problem here is that an aqueous solution of flocculating agent of this type undergoes aging because of hydrolysis. During aging, the charge density of the batch solution (or of the flocculating agent contained in it, such as a polymer) decreases continuously. As already mentioned, the method can be carried out in a manner such that when determining the quantity of flocculating agent to be added at a specific time point, the quantity to be added at a time point before the relevant time point can be taken into consideration. Dosing the flocculating agent in this manner as a function of a previously added quantity of flocculating agent ensures that the aging of the batch solution works only on the difference in the target charge density. The basic quantity of charge remains unchanged, as long as flocculating agent is continuously fed into the suspension. As long as the quality (i.e. the chemical composition) of the suspension remains largely constant, then the effects of polymer aging can be compensated for in the time periods under consideration.

Furthermore, other strategies may be envisaged in order to balance out the effects of aging in the flocculating agent. Initially, at each time point for addition (the time point for addition follows the respective measurement time points), an expected value for the charge density is defined which is compared with the measured charge density in the subsequent measurement. From the quotient of the expected value and the measured value, an aging factor can be calculated, by which the determined dosing value or additional quantity is multiplied. The aging factor functions like a correction factor. In a strategy of this type, however, disadvantageously, those variations in the flocculating agent charge density which cannot be attributed to aging of the flocculating agent per se (for example variations on the basis of variations in the composition of the suspension) cannot be taken into consideration with a correction value of this type.

Furthermore, aging effects in the flocculating agent may be taken into consideration by using empirically determined correction factors. This may involve empirically determined data regarding the aging of a specific flocculating agent (whether in the form of value tables or empirical formulae). The only disadvantage in this regard is that varied aging rates due to variations in the composition of the aqueous components of the batch solution or of the flocculating agent per se cannot be taken into consideration with this method.

A further method for taking aging effects of the flocculating agent into consideration may be constituted by determining the charge density of the flocculating agent or of the batch solution for the flocculating agent at regular intervals and taking the respective prevailing determined values for the flocculating agent charge density into consideration in the calculations for the required quantity to be added. Using such a procedure means that the most reliable and precise results can be obtained. In this embodiment, however, the technical conditions must be generated for determining the charge density of the flocculating agent in a regular manner. By constructing the measurement device as a separate component to the dewatering assembly (for example a decanter centrifuge or screw press), it must be ensured that a reservoir of flocculating agent is provided in the measurement device with access to manual or automatic sample removal, so that at specified time points, a sample of the flocculating agent can be removed for charge density determination. In the case of an automated charge density determination of the flocculating agent, the measurement may be carried out in the context of a multi-channel system instead of a determination of the charge density of the suspension in the measurement device per se. The interval in which a charge density determination for the suspension is replaced by a charge density determination for the flocculating agent may be freely selected; in this case, the dose (the quantity to be added) is specified for the duration of the determination. Similarly, extending the measurement device with an additional unit for determining the charge density of the flocculating agent is possible, for example using an additional titration unit.

As already mentioned, it may be advantageous to monitor the flocculating agent charge density at defined chronological intervals. This repetitive procedure may be carried out via a processing and control unit. The chronological intervals for monitoring the flocculating agent charge density in this regard can be longer than the intervals of time between the measurement time points for measuring the suspension charge density.

In accordance with a further embodiment, a charged polymer, for example a polyelectrolyte, may be used as the flocculating agent. In general, flocculating agents based on polymers are termed polymeric flocculating agents (pFA). In principle, it should be mentioned at this juncture that the selection of the flocculating agent, or in the current context the selection of the polymer, is governed by the type and composition of the suspension to be dewatered. As an example, a specific polymer may be suitable for an aqueous sewage sludge, but is unsuitable for the flocculation of solid particles in a suspension occurring during the production of paper. Thus, the invention is not limited to a specific polymer for use as a flocculating agent, but rather, all known polymers which are known and used or become known or used as flocculating agents for the respective suspensions may be used. example, organic, high molecular weight and water-soluble polyelectrolytes may be used. These may be produced synthetically. As an example, polyelectrolytes based on polyacrylamide or, more generally, polymers based on acrylic acid, may be considered. Furthermore, polymers based on acrylic acid additionally polymerized with copolymers may be considered (for example ADAME-quat, MADAME-quat or DIMAPA quat), wherein the charge-functional groups may be provided by the additionally polymerised copolymer. At the same time, the flocculating agent may be a biopolymer with a natural charge-functional group or an additionally polymerised charge-functional group. As already mentioned above, flocculating agents in the purification of communal and industrial waste in sewage treatment plants, in recycling of process and circulation water as well as the clarification of untreated water or surface water for the production of process water or drinking water may be used. The flocculating agents are tasked with accelerating the sedimentation or flotation of solid particles and the dewatering of suspensions during thickening. Many dewatering assemblies such as centrifuges, decanters or band filters can barely function without the addition of flocculating agents.

In accordance with a further embodiment, an anionic or a cationic polymer may be used as the flocculating agent. Cationic charges on polymers may, for example, be formed by additionally polymerized functional groups. Examples that may be cited are ADAME quat, MADAME quat or DIMAPA quat as a possible copolymers polymerized onto a polymer. Examples of anionic flocculating agents are sodium propionate. It may also be the case, depending on the charge density in the suspension to be dewatered, that an appropriate anionic or cationic polymer may be selected as the flocculating agent. In this regard, separated reservoirs for storing anionic polymers and cationic polymers may be provided in a dewatering assembly. A processing and control unit may be used to control a supply unit connected to the reservoirs in a manner such that a specific quantity of either the anionic or cationic polymer is introduced into the dewatering assembly.

In accordance with a further advantageous embodiment of the method, the suspension charge density may be determined at regular or irregular chronological intervals, wherein the chronological intervals may be manually or automatically determined. The shorter the chronological intervals between the measurement time points of the suspension charge density, the more precise is the method control and the associated adjustment of the optimal flocculation conditions. The more often the suspension charge density is checked in a specific time period (and the flocculating agent added to guarantee the optimal flocculation conditions), the shorter are any time periods with less than optimal flocculation conditions. However, the suspension charge density may also be checked at irregular intervals of time, for example as a consequence of a manual command input. This may, for example, be necessary if operatives of a dewatering assembly determine that the flocculation process is deviating from ideal flocculation on the basis of operational parameters of the dewatering assembly or on the basis of visual inspection.

In accordance with a further embodiment, the suspension charge density may be determined in a streaming potential measuring cell, wherein a defined sample volume of the suspension is automatically supplied to the streaming potential measuring cell. The streaming potential measuring cell may be a component of a higher-level measurement device or of a measurement system. The measurement device (including the measuring cell) may be integrated into a dewatering assembly or at least connected to it, both from a control engineering viewpoint as well as in order to guarantee (automated) sample removal at the specified measurement time points.

According to a further embodiment, at least the steps c. and d. of the method may be carried out automatically using a processing and control unit. The processing and control unit may be a component of the measurement device. Accordingly, the measurement device (including the processing and control unit) may be portable in construction and be implemented in a wide variety of dewatering assemblies or be connected to it in a control engineering manner. In addition, the measurement device may have a sample removal unit, for example a pump. In the case of a portable configuration of the measurement device, the sample removal device may be connected to the dewatering assembly via a feed line so that the measurement device can (automatically) take samples from the suspension to be dewatered. The processing and control unit of the measurement device may be connected to the control of the dewatering assembly in a control engineering manner. In the case of a portable measurement device, for example, this may be via a wireless data link or, alternatively, via a signal and data transmission cable. The measurement device or the processing and control unit is therefore provided with a suitable data interface. In the case of direct structural integration of the measurement device into a dewatering assembly, a common processing and control unit may be provided for controlling the dewatering assembly as well as the measurement device. In any case, the processes of flocculating agent addition and the measurement are coordinated with each other in a control engineering manner. In practice, this means that, after determining the quantity of flocculating agent to be added at a specific time point, the processing and control unit sends a command for dosing an appropriate quantity of flocculating agent to a corresponding unit of the dewatering assembly.

In accordance with a further embodiment, the determination and addition of the required quantity of flocculating agent to be added is based on quantitatively proportional control, load-proportional control, proportional regulation or PID regulation.

As already mentioned above, appropriate addition of flocculating agent to the system to be dewatered (for example a solid-liquid suspension) can be performed. Here, “appropriate” means that the quantity of the flocculating agent added to the suspension at a specific point in time of the dewatering process is matched to current conditions prevailing in the suspension and the flocculating agent, in order to guarantee successful and efficient flocculation of the dewatering process over the entire time period. The addition of the flocculating agent may in this regard be controlled in a variety of ways.

Four different variations of the method for regulating the addition of the flocculating agent addition will be described below. Accordingly, all four of the variations of the method described below are incorporated into the subject matter of the methods herein and therefore constitute embodiments of the invention.

Firstly, the determination and addition of the required quantity of flocculating agent to be added may be based on a quantitatively proportional regulation. In quantitatively proportional regulation, the addition of the flocculating agent is proportional to the quantity supplied to the separating assembly in which the suspension to be dewatered is located. The separation assembly (for example decanter centrifuge) is consequently to be construed as a physical container or a physical device in which the solid-liquid separation is carried out. As a rule, the quantity which is supplied is fixed. Usually, the quantity of flocculating agent in quantitatively proportional regulation is calculated so as to be proportional to the supplied quantity, for example by establishing a quantity to be added in litres per hour. In a quantitatively proportional regulation, the quantity to be added is, as a rule, not given as a weight of the flocculating agent to be added per unit volume or unit time. Accordingly, in such a regulation, the batch concentration of the flocculating agent (for example of an aqueous polymer solution) is taken into consideration. This concentration may either be stored in the processing and control unit or be measured in the measurement device or externally. In quantitatively proportional regulation or dosing, the quantity to be added (following a specific measurement time point) can be calculated as follows:

Dp,N=Dp,A+(dEqZ−dEqM)/dEqp

wherein Dp,N is the quantity to be added at a time point N, Dp,A is the quantity to be added at a time point A immediately before the time point N, dEqZ is the target charge density of the suspension, dEqM is the suspension charge density determined at a measurement time point associated with the time point N and dEqp is the flocculating agent charge density. Deviations from the ideal dimensions of the parameters can be taken into account by means of correction factors or by means of recalculation with known variables.

In the case of load-proportional regulation, a dose parameter or parameter for the quantity to be added is specified. As a rule, the dose parameter in this regard has the dimensions of kilograms of flocculating agent per tonne of solid content of the suspension. It is known from the prior art to fix the dose value, but in contrast, in the context here, the dose value can be determined continuously as a variable value. In the ideal case, the dose or addition value has the dimensions of litres of flocculating agent per kilogram of solid content of the suspension. Accordingly, such a type of regulation is only possible when a solid probe is provided in the suspension feed line of the dewatering assembly in order to determine the solid content. Examples of suitable solid probes which may be considered are optical methods based on light scattering or microwave radiation. The solids content of the suspension in this regard is, as a rule, given in the dimensions of kilograms of dry substance per litre of suspension.

In load-proportional regulation or dosing, the quantity to be added (at a specific measurement time point) can be calculated as follows:

D′p,N=D′p,A+((dEqZ−dEqM)/dEqp)/fTSS

wherein D′p,N is the quantity to be added at a time point N, D′p,A is the quantity to be added at a time point A immediately before the time point N, and fTSS is the solid content of the suspension. The variables dEqZ, dEqM and dEqp are equivalent to the definitions given above in the context of quantitatively proportional regulation. Here again, with load-proportional regulation, deviations from the ideal dimensions of the parameters can be taken into account by means of correction factors or by means of recalculation with known variables.

In the case of proportional regulation, the suspension charge density in the eliminated liquid phase of the suspension is determined and a difference between the target charge density and the determined charge density is formed. A quantity to be added can then be calculated by multiplication with a specific dosing factor. In this regard, the dosing factor can assume a fixed value, or it may be taken from a stored data table. The dosing factor is an empirically determined value. The dosing factor may also be approximately estimated using theoretical value pairs via the calculation bases for quantitatively proportional regulation or load-proportional regulation. In proportional regulation, the quantity to be added (at a specific measurement time point) can be calculated as follows:

D″p,N=D″p,A+((dEqZ−dEqM)/dEqp)×FD

wherein D″p,N is the quantity to be added at a time point N, D″p,A is the quantity to be added at a time point A immediately before the time point N, and FD is the unitless (and empirically determined) dosing factor. The variables dEqZ, dEqM and dEqp are equivalent to the definitions given above in the context of quantitatively proportional regulation. Here again, with proportional regulation, deviations from the ideal dimensions of the parameters can be taken into account by means of correction factors or by means of recalculation with known variables.

Furthermore, the determination and addition of the required quantity of flocculating agent to be added may be based on PID regulation. A PID (proportional-integral-derivative controller) comprises a P member (proportional controller), an I member (integral controller) and a D member (differential controller) and can be defined both in a parallel structure and also in a series structure. The measured suspension charge density is compared with the target charge density using a PID controller. The controller raises or reduces the quantity of the flocculating agent to be added until the target charge density is reached.

In accordance with a further embodiment, the method may be provided for use in a continuous dewatering process for solid-liquid suspensions.

Advantageously, the methods disclosed herein may be used in a process for dewatering sewage sludge. Sewage sludge is relatively turbid compared with many other solid-liquid suspensions (for example sand in water). Accordingly, optical methods for determining the charge density are of only limited use. Because of the streaming potential-based measurement of the suspension charge density, the present method is independent of the degree of turbidity. Consequently, the invention comes to the fore in the context of processes for dewatering turbid suspensions such as sewage sludge.

The method can clearly be used in the filtration, sedimentation, flotation, thickening or dewatering of sewage sludge. Finally, the method may be used in any steps of a dewatering process in which flocculation of solid particles of the suspension is carried out. At this juncture, it should be emphasized that the measurement of the suspension charge density may also be carried out using the streaming potential measuring cell in the untreated feed line for the dewatering assembly. In this regard, though, there is no excess or deficit of flocculating agent, but rather the actual total requirement of flocculating agent in the suspension to be treated.

A measurement device containing the measuring cell for carrying out the titrimetric analysis in the context of step c. of the method may be used both in the feed line and also in the discharge of a dewatering assembly. In this regard, as mentioned above, the measurement device may also comprise other components, for example a processing and control unit and a device for removing samples.

The systems disclosed herein can implement flocculating solid particles contained in a suspension. Exemplary systems comprise a processing and control unit, a measuring cell, and a dosing unit, wherein the processing and control unit is connected to the measuring cell and the dosing unit in a signal engineering manner. In this regard, said components (at least the processing and control unit and the measuring cell) may also be structurally combined, for example in a common housing. The system may be installed permanently in a dewatering assembly or it may be mobile in configuration.

The measuring cell belonging to the system is configured to determine the suspension charge density present in the suspension at a plurality of measurement time points by way of a titrimetric analysis via measurement of the streaming potential and to transfer the data obtained to the processing and control unit.

The processing and control unit which also belongs to the system is configured to calculate a quantity of flocculating agent to be added which is required at the respective measurement time points in order to guarantee optimal flocculation based on the suspension charge density determined at the respective measurement time point, a target charge density of the suspension which is provided, as well as a flocculating agent charge density. In principle, the processing and control unit does not have to be physically connected to the other components, i.e. it does not necessarily have to be combined with the measuring cell in a single housing. The processing and control unit may even be located on an external server, which is connected to an interface disposed on the measuring cell for exchange of data via a signal and data connection.

Furthermore, the processing and control unit is configured to transfer a dosing signal based on the required quantity of the flocculating agent to be added to the dosing unit. The required quantity of flocculating agent to be added is added to the suspension to be dewatered in correspondence with the dosing signal (the dosing unit is thus configured to add the required quantity of flocculating agent to be added to the suspension as a consequence of the dosing signal). In this regard, the dosing unit is exemplarily located directly on the dewatering assembly. Both the dosing unit and also the measuring cell may be provided with micro-controllers which exchange signals and data with the processing and control unit. The system (whether it is the processing and control unit or the measurement device containing the measuring cell) can in addition have a display unit via which the result of individual measurements or the entire profile of the method can be displayed to a user.

This summary is not exhaustive of the scope of the present aspects and embodiments. Thus, while certain aspects and embodiments have been presented and/or outlined in this summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations, and/or claims, which follow.

It should also be understood that any aspects and embodiments that are described in this summary and do not appear in the claims that follow are preserved for later presentation in this application or in one or more continuation patent applications.

### BRIEF DESCRIPTION OF THE DRAWINGS

Further embodiments and developments will now be explained in more detail with the aid of the exemplary embodiments described below. These are intended to illustrate embodiments of the invention to the person skilled in the art so that the invention can be carried out by the person skilled in the art, but are not intended to limit the invention. In connection with the description of said exemplary embodiments, reference is made to the following figures with the aid of which the embodiments are described in more detail. In the drawings:

FIG. 1 shows a diagrammatic overview of the system for use in a decanter centrifuge as an exemplary dewatering assembly, in respect of quantitatively proportional regulation, proportional regulation and PID regulation;

FIG. 2 shows a diagrammatic overview of the system for use in a decanter centrifuge as an exemplary dewatering assembly, in respect of load-proportional regulation, proportional regulation and PID regulation; and

FIG. 3 shows a diagrammatic view of the sequence of a method.

### DETAILED DESCRIPTION OF EMBODIMENTS

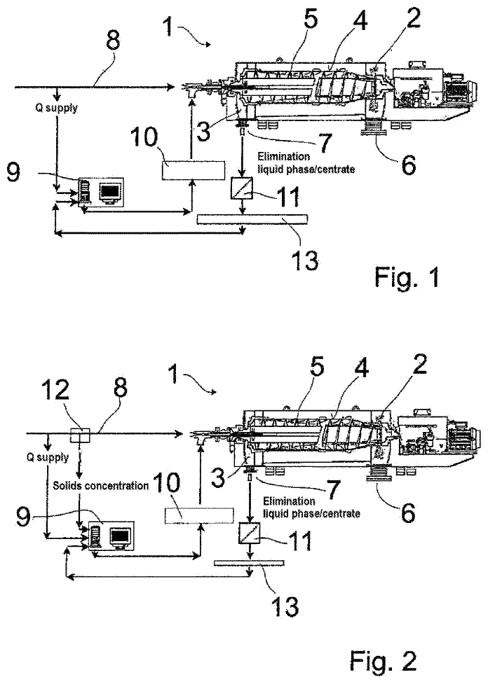

FIGS. 1 and 2 show the system for use in connection with a decanter centrifuge 1 as an exemplary dewatering assembly. It should be expressly stated at this juncture that this is merely an exemplary representation with the aid of which a system or method can be illustrated. Equally, the system or method may also be used in other types of dewatering assemblies.

With a decanter centrifuge 1 of this type, a phase separation of a suspension can be carried out, for example in the context of a sewage sludge dewatering process. In this regard, the solid particles 2 contained in the suspension (for example sewage sludge) are separated from the liquid phase (for example water) and eliminated. To this end, in the centrifuge, gravitational acceleration is replaced by the substantially higher centrifugal acceleration. Because of their higher density, the solid particles 2 collect at the wall of the bowl 4 and are transported with the aid of a screw conveyor 5 to corresponding outlet openings 6. At the same time, the clarified liquid 3 flows along the screw conveyor 5 into the liquid outlet zone 6.

FIG. 1 illustrates the diagrammatic sequence of quantitatively proportional regulation of the addition of flocculating agent. By means of an infeed stream 8, the decanter centrifuge 1 is supplied with the suspension to be dewatered (the sewage sludge). This may be continuous or discontinuous. The term “continuous supply” in this regard should be understood to mean a supply with a continuous volumetric flow of the suspension. The term “discontinuous supply” means that the decanter centrifuge 1 is fed with a fixed volume of a suspension; in this case, the supply is not continuous, but batchwise. Prior to the start of the dewatering process occurring in the centrifuge 1, the target charge density dEqZ of the suspension is specified, i.e. a target value at which an optimal flocculation occurs which is aimed for during dewatering. In at least one embodiment, the target charge density dEqZ corresponds to that charge density at the isoelectric point of the suspension. The target charge density dEqZ may, for example, be determined in the context of a separate laboratory test. In addition, a sample may be removed from the infeed stream 8 and analysed. The target charge density dEqZ determined in this manner can be provided to a processing and control unit 9 for further implementation of the method, for example by manual inputting by a user. Furthermore, said procedure (sample removal from the suspension, determination of the target charge density dEqZ) may also proceed in an automated manner. Other types of methods for the determination or for specifying the target charge density may be used in the context. The method is controlled and regulated in the processing and control unit 9.

As can also be seen in FIG. 1, the processing and control unit 9 regulates the addition of the flocculating agent required for flocculation or dewatering, for example by means of a dosing unit 10 provided for that purpose. In the context, the charge density dEqp of the flocculating agent used is known and the method uses it as an input parameter. The processing and control unit 9 uses the flocculating agent charge density dEqp when executing the method. In this regard, the flocculating agent charge density dEqp can be specified by a manufacturer or provider of the flocculating agent, or in fact be determined by the user per se (whether that is a consumer such as a client or the marketer such as a merchant or service provider), for example in the context of a laboratory test. The flocculating agent charge density dEqp may be monitored at a plurality of time points in the method or the dewatering process. Previously determined values are then replaced by the prevailing determined values.

After supplying the decanter centrifuge 1 with the suspension to be dewatered, the suspension charge density dEqM in the suspension (at the respective time points) is determined at a plurality of measurement time points. In addition, a sample is removed (for example from the liquid discharge zone 7 of the decanter centrifuge 1) and the suspension charge density dEqM is determined by way of a titrimetric analysis by measuring the streaming potential. Sampling may, for example, be carried out by means of a sampling unit 11 provided especially for sample removal. The sampling unit 11 in this regard may be controlled by the processing and control unit 9 and be commanded to take samples at the respective measurement time points. The sampling unit 11 may also have a microcontroller in which the appropriate time points for taking samples are specified or programmed. The actual determination of the suspension charge density is carried out in a measuring cell 13. The sample removal together with the subsequent titrimetric analysis are part of the routine of the method. The measured suspension charge density dEqM is transmitted to the processing and control unit 9—as indicated by the path of the arrows.

The processing and control unit 9 determines the required quantity Dp of flocculating agent to be added at the respective measurement time points in order to guarantee continuous optimized flocculation. The quantity Dp of the flocculating agent to be added in this regard is determined on the basis of the target charge density dEqZ, the flocculating agent charge density dEqp and the suspension charge density dEqM at the respective measurement time point.

Following the respective measurement time points, the required quantity of flocculating agent is added to the dewatering assembly or the decanter centrifuge 1 via a dosing unit 10. If at a specified time point no further addition of flocculating agent is required, the processing and control unit 9 does not transmit an “add” command to the dosing unit 10.

The protocol of the method which has been described enables an appropriate addition of a flocculating agent to be provided, avoiding under-dosing and over-dosing.

FIG. 2 shows a diagrammatic representation of the system or method under load-proportional regulation. Compared with quantitatively proportional regulation (see FIG. 1), the processing and control unit 9 uses additional information at the initial time point (i.e. prior to the dewatering). The solids content may, for example, be determined by means of a solids probe 12 which is installed in the suspension feed line for the separation assembly (in this case the decanter centrifuge 1). The other components shown in FIG. 2 correspond to those in the view of FIG. 1 and the system components described above. For details of the regulation used in the context (for example quantitatively proportional regulation, load-proportional regulation, proportional regulation, PID regulation), reference should be made to the section of the description above pertaining to the description of the figures.

As has already been described, the present invention also comprises a system for carrying out the method. The essential components of the system are the processing and control unit 9, the measuring cell 13, and the dosing unit 10.

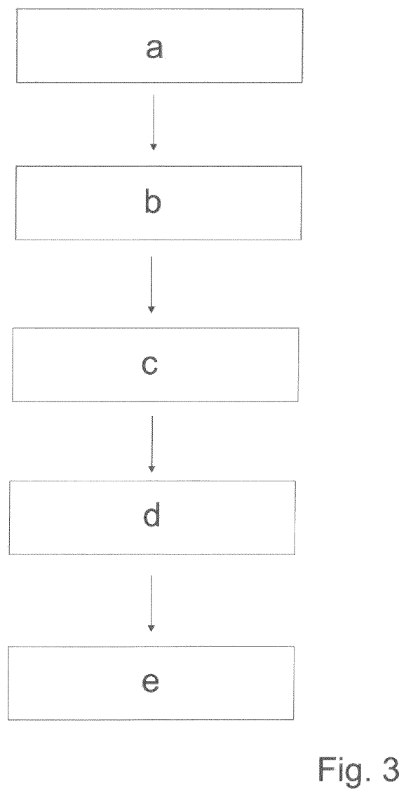

FIG. 3 highly diagrammatically shows the individual steps of the exemplary method.

Thus, in a step a. of the method, a suspension is provided and a target charge density dEqZ for the suspension is specified, but with the proviso that the target charge density dEqZ is that charge density of the suspension at which the solid particles flocculate. In a step b. of the method, a flocculating agent is provided, wherein the flocculating agent has a flocculating agent charge density dEqp. According to a step c. of the method, the suspension charge density dEqM in the suspension is determined at a plurality of measurement time points by way of a titrimetric analysis with measurement of the streaming potential. In a subsequent step d. of the method, a quantity Dp of the flocculating agent to be added in order to guarantee an optimal flocculation is calculated at the respective measurement time points, namely based on the target charge density dEqZ, the flocculating agent charge density dEqp and the suspension charge density dEqM at the respective measurement time point. According to a step e. of the method, following the respective measurement time points, the determined quantity Dp of the flocculating agent to be added to the suspension is specified.

Depending on the number of measurement time points, steps c. to e. are repeated by the number of times which corresponds to the number of measurement time points.

While the above describes certain embodiments, those skilled in the art should understand that the foregoing description is not intended to limit the spirit or scope of the present disclosure. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

1. A method for flocculating solid particles (2) contained in a suspension, comprising the following steps:
a. preparing a suspension and specifying a target charge density (dEqz) for the suspension, wherein the target charge density (dEq_{z}) defines a charge density of the suspension at which the solid particles (2) flocculate;
b. at a plurality of measurement times: determining a suspension charge density (dEq_{M}) in the suspension using of a titrimetric analysis with measurement of streaming potential of the suspension;
c. each respective measurement time of the plurality of measurement times, determining a required quantity (Dₚ) of a flocculating agent defining a flocculating agent charge density (dEqₚ) to be added to the suspension to optimize flocculation based on the target charge density (dEq_{Z}), the flocculating agent charge density (dEqₚ) and the suspension charge density (dEq_{M}) at said each respective measurement time; and
d. e. subsequent to said each respective measurement time, adding to the suspension the determined quantity (Dp) of flocculating agent to be added.

2. The method as claimed in claim 1, wherein the step of specifying the target charge density (dEqZ) includes determining the target charge density (dEqZ) using a separate laboratory test.

3. The method as claimed in claim 2, wherein the step of determining the target charge density (dEq_{Z}) includes determining the target charge density (dEqZ) of a specific suspension once or in a repeated manner.

4. The method as claimed in claim 1, further including determining the flocculating agent charge density (dEqₚ) from empirical data in a separate investigation.

5. The method as claimed in claim 3, further including monitoring the flocculating agent charge density (dEqₚ) at defined chronological intervals.

6. The method as claimed in claim 1, wherein the flocculating agent is a charged polymer.

7. The method as claimed in 6, wherein the flocculating agent is an anionic or a cationic polymer.

8. The method as claimed in claim 1, wherein the step of determining the suspension charge density (dEq_{M}) includes determining the suspension charge density (dEq_{M}) at regular or irregular chronological intervals determined manually or automatically.

9. The method as claimed in claim 1, wherein the step of determining the suspension charge density (dEq_{M}) includes automatically supplying a defined sample volume of the suspension to a streaming potential measuring cell, and determining the suspension charge density (dEqM) in the streaming potential measuring cell.

10. The method as claimed in claim 1, including performing at least the steps b. and c. automatically using a processing and control unit (9).

11. The method as claimed in claim 1, wherein the steps of determining and adding the required quantity (Dp) of flocculating agent to be added include using quantitatively proportional control, load-proportional control, proportional regulation or PID regulation.

12. The method as claimed in claim 1, including performing steps a.-d. in a continuous dewatering process for solid-liquid suspensions.

13. The method as claimed in claim 1, including performing steps a.-d. in a process for dewatering sewage sludge.

14. The method as claimed in claim 13, wherein said process for dewatering sewage sludge includes filtration, sedimentation, flotation, thickening and/or dewatering of sewage sludge.

15. A system configured for flocculating solid particles (2) contained in a suspension, comprising:
a processing and control unit (9), a measuring cell (13) and a dosing unit (10),
wherein the processing and control unit (9) is operatively connected to the measuring cell (13) and the dosing unit (10) for signal transmission therebetween, wherein:
the measuring cell (13) is configured to determine a suspension charge density (dEq_{M}) in the suspension at a plurality of measurement times using a titrimetric analysis with measurement of streaming potential of the suspension, and to transfer data obtained thereby to the processing and control unit (9);
the processing and control unit (9) is configured to:
a. calculate, at each respective measurement time of the plurality of measurement times, a quantity (Dp) of flocculating agent required to be added to the suspension to optimize flocculation based on the suspension charge density (dEqM) determined at said each respective measurement time, a specified target charge density (dEqZ) for the suspension, and a flocculating agent charge density (dEqp) of the flocculating agent, and
b. transmit to the dosing unit a dosing signal based on the required quantity (Dp) of the flocculating agent to be added to the suspension; and
the dosing unit (10) is configured, based on of the dosing signal, to add to the suspension the required quantity (Dₚ) of the flocculating agent to be added.
